(19) United States
(12) Patent Application Publication
(10) Pub. No.: US 2002/0119323 A1
(43) Pub. Date: Aug. 29, 2002

(54) Compressible polyurethane layer and process for the preparation therof

(76) Inventor: Johann Weinert, Kerpen (DE)

Correspondence Address: JACOBSON HOLMAN PLLC, 400 SEVENTH STREET N.W., SUITE 600, WASHINGTON, DC, 20004, US

(21) Appl. No.: 10/014,446

(22) Filed: Dec. 14, 2001

Related U.S. Application Data
(60) Provisional application No. 60/277,934, filed on Mar. 23, 2001.

(30) Foreign Application Priority Data
Dec. 15, 2000 (DE) 100 62 628.9

(51) Int. Cl. C08J 9/18; B32B 9/04

(52) U.S. Cl. 428/423.1; 521/60

(57) ABSTRACT

The compressible polyurethane layer having outer and inner surfaces on or for rotation-symmetrical bodies consists of polyurethane and contains expanded and/or non-expanded, but expandable thermoplastic hollow spheres.

The present invention relates to a compressible polyurethane layer having outer and inner surfaces on or for rotation-symmetrical bodies, and methods for the preparation thereof.

In the offset printing process, rubber blankets are employed for applying a printed image to a sheet or web material. The rubber blankets are often arranged and supplied on sleeves. The rubber blankets consist of a multilayered material. Thus, for example, EP-A-0 594 986 describes a rubber blanket which consists of a sleeve of nickel steel or plastic onto which a rubber blanket in the form of a rubber coat is applied. Further, EP-A-0 594 986 discloses a reinforced carrier sleeve to which the rubber blanket is then applied.

The materials from which the multilayered rubber sleeves can be prepared contain in part non-compressible elastic materials, such as rubber, or compressible materials as described in EP-A-0 388 740.

U.S. Pat. No. 6,146,748 describes a lithographic layer for a printing blanket and a printing blanket fitted with this layer, which comprises an elastomer material having a multiplicity of voids in the elastomer material, wherein the voids are constituted by expandible or pre-expanded microspheres located within the elastomer material and make the lithographic layer slightly compressible. The layer has a thickness of less than 0.7 mm. The elastomer may be vulcanizable nitrile rubber or a cross-linked or non cross-linked thermoplastic elastomer.

One particular problem in the handling of the conventional rubber blanket sleeves for offset printing is that the rubber blankets are shipped on carrier sleeves. However, such structures are very sensitive towards mechanical actions since the whole layer structure of carrier and rubber blanket is relatively thin.

Thus, when shipped, such sleeves must be protected against mechanical influences with a high expenditure. Also, due to the bulkiness of the conventional rubber blankets constructed on sleeves, intensive stock keeping is required by the user. Both in shipping and in stock keeping, a very high volume is demanded, which causes considerable costs including those for providing corresponding buildings (e.g., stock rooms).

From DE 39 08 999 C2, a cylindrical body is known which has a seamless layer applied to its lateral area, which layer is compressible, comprises closed hollow cells and is prepared by applying the material to the cylindrical body in a somewhat spiral manner with rotation and advance in the form of a fleece-shaped foam to which blowing agents and inhibitors have been added. As a blowing agent for foaming, methylene chloride is mentioned, for example, which is to be avoided, however, for reasons of exhaust-air pollution, if possible.

When the coating material is a polyurethane, it also is possible in principle to perform the foaming with air or carbon dioxide. However, it is extremely difficult to set reproducible conditions in this case and thus to obtain a uniform quality of the compressible layer.

In addition to sleeve-shaped rubber blankets pulled over an air mandrel, rubber blankets clamped on a cylinder with fixing members, wherein a certain distance between the two blanket ends results, are also used to a considerable extent. For those rubber blankets too, a compressible polyurethane layer which can be prepared in an easily reproducible way would be desirable.

Finally, a compressible polyurethane layer permanently applied to a roller surface would be desirable.

Thus, it has been the object of the invention to provide a compressible polyurethane layer having outer and inner surfaces on or for rotation-symmetrical bodies which can be prepared in a simple, inexpensive and closely reproducible way. This object is achieved by the polyurethane layer containing expanded and/or non-expanded, but expandable thermoplastic hollow spheres.

Particularly useful are hollow spheres made of an acrylate/vinylidene fluoride copolymer. Such expanded hollow spheres are prepared and sold, for example, by Akzo Nobel under the designation of “Expancel®”. These hollow spheres are offered of various thermoplastic materials having different softening temperature ranges. These are prepared from hollow spheres which are not expanded at first, for example, containing a low-boiling liquid hydrocarbon which results in a strong expansion upon heating and softening of the thermoplastic material. Only when the optimum expansion temperature is exceeded, there is so strong an expansion that the hollow spheres burst and thus lose their optimum function. If desired, the thermoplastic hollow spheres are also supplied in a non-expanded form. In this case, of course, they have significantly lower diameters. While the non-expanded hollow spheres have diameters, for example, of from 6 to 16 μm, preferably from 6 to 9 μm, these spheres, when in expanded form, can altogether have diameters of from 20 to 60 μm, preferably from 30 to 50 μm. However, diameters as large as 100 μm in expanded form are altogether possible and are also prepared and sold.

Since rubber blankets for offset printing should have a surface roughness, Rₐ, within a range of from 0.5 to 2.0 μm, the rubber blankets according to the invention have a thin layer of polyurethane towards the outer surface which contains slightly expanded or non-expanded hollow spheres or none at all. This thin polyurethane layer can then be ground in a particularly simple way to provide the desired roughness.

The polyurethane layers according to the invention are prepared by applying a freshly prepared mixture of diisocyanate and polyol or polyamine by rotational casting to a roller or roller-shaped air cylinder or a metal or plastic carrier pulled thereon, one or both of the two components containing said expanded and optionally non-expanded hollow spheres.

After surface processing, sleeve-shaped rubber blankets are removed from the air cylinder so that shipping and storage thereof become possible. The finished sleeve-shaped rubber blanket is slipped on the respective rubber blanket cylinder by the user by means of compressed air, and fixed thereon after the air supply has been discontinued. Rubber blankets prepared on a plastic sleeve or without a plastic sleeve can be shipped and stored in a particularly space-saving way. However, if desired, the sleeve-shaped rubber blankets may also be cut open and used for rollers having a cleft and fixing means. Rollers with a permanent coating are optionally subjected to an additional surface processing.

The quantity and size of expanded thermoplastic hollow spheres added to the polyurethane in accordance with the invention is strongly dependent on the desired compressibility of the rubber blanket or of the polyurethane layer. Preferred ranges of quantities are from 0.5 to 6% by weight; they already result in an elastic cell volume of over 50% by volume of the polyurethane layer. Thus, the compressibility, buffing and rebound elasticity of the polyurethane layer can be easily and reproducibly adjusted. The components of the polyurethane employed, namely diisocyanate and polyol or polyamine are adjusted to a very short top life in the seconds range. The expanded hollow spheres, but optionally also non-expanded hollow spheres, can be admixed with either of these two components. It is particularly easy to admix them with the polyol or polyamine component. Generally, the addition of the hollow spheres already results in an altogether remarkable thixotropation both of the individual components and of the freshly prepared mixture which forms the polyurethane. Of course, further additives, such as thickeners, thixotropic agents, accelerators, retarders or liquefiers, can be added to one or both of the components. In rotational casting, the mixture of diisocyanate, polyol or polyamine and hollow spheres is sprayed in a generally spiral manner onto the roller-shaped carrier. This may be done in one or more runs; it is particularly preferred to prepare the last outer surface from a polyurethane which does not contain any hollow spheres or non-expanded hollow spheres, because the desired roughness can then be achieved more easily during the grinding. When non-expanded hollow spheres are used, the expansion may also be effected after the fabrication of the PU layer by appropriate heating at between 100 and 150° C.; if necessary, the thermoplastic sleeve may also be molten. Depending on the specific application, the compressible PU layer may also be provided with a non-compressible cover layer of PU or other materials. The coatings described are usually electrically insulating materials; however, by the addition of appropriate additives, defined resistivities within a range of from 10³ to 10⁹ Ω-cm may also be adjusted. The individual materials may preferably be applied in the following layer thicknesses:

| | |
|---|---|
| compressible layer: | 0.3-50 mm |
| non-compressible layer: | 0.3-40 mm. |

The polyurethane layers according to the invention are generally prepared within a hardness range of from 15 Shore A to 90 Shore D. Depending on the specific application, the cover layer can have different physicochemical properties, such as hydrophilic, hydrophobic, lipophilic, lipophobic, electrically insulating, electrically conductive, thermally insulating or thermally conductive. The overall structure may consist not only of two layers, but also alternately of several compressible and non-compressible layers.

1. A compressible polyurethane layer having outer and inner surfaces on or for rotation-symmetrical bodies, characterized in that said polyurethane layer contains expanded and/or non-expanded but expandable thermoplastic hollow spheres.

2. The polyurethane layer according to claim 1, characterized in that said hollow spheres consist of an acrylate/vinylidene fluoride copolymer.

3. The polyurethane layer according to claim 1 or 2, characterized by having a thin layer of polyurethane towards the outer surface which contains non-expanded or no hollow spheres.

4. The polyurethane layer according to any of claims 1 to 3, characterized in that said expanded hollow spheres have diameters of from 20 to 100 μm, preferably from 30 to 50 μm.

5. The polyurethane layer according to claim 3 or 4, characterized in that said non-expanded hollow spheres have diameters of from 6 to 16 μm, preferably from 6 to 9 μm.

6. The polyurethane layer according to any of claims 1 to 5, characterized in that the inner surface of the polyurethane layer is in contact with a carrier made of metal or plastic.

7. A method for the preparation of a compressible polyurethane layer having outer and inner surfaces on or for rotation-symmetrical bodies according to claims 1 to 6, characterized in that a freshly prepared mixture of diisocyanate and polyol or polyamine is applied by rotational casting to a roller-shaped carrier, one or both of the two components containing said expanded and optionally the non-expanded hollow spheres, followed, if desired, by withdrawing the polyurethane layer from the carrier and, if desired, by cutting it open.
